(19) United States
(12) Patent Application Publication
(10) Pub. No.: US 2017/0254051 A1
(43) Pub. Date: Sep. 7, 2017

(54) WIRELESS SENSOR NETWORK FOR DETECTING EQUIPMENT FAILURE

(71) Applicants: Hossam S. HASSANEIN, (US); Abdallah Y. ALMA'AITAH, Irbid (JO); SYNCRUDE CANADA LTD.in trust for the owners of the Syncrude Project, as such owners exist now and, Fort McMurray (CA)

(72) Inventors: Hossam S. HASSANEIN, Kingston (CA); Abdallah Y. ALMA'AITAH, Irbid (JO); Khaled OBAIA, Edmonton (CA)

(21) Appl. No.: 15/447,606

(22) Filed: Mar. 2, 2017

Related U.S. Application Data
(60) Provisional application No. 62/302,909, filed on Mar. 3, 2016.

(51) Int. Cl. E02F 9/26; H04L 12/24; G07C 5/08; H04W 4/00

(52) U.S. Cl. CPC E02F 9/267; H04W 4/005; H04L 41/069; H04W 4/008; G07C 5/0816

(57) ABSTRACT

A monitoring system, hardware, and methods are provided for monitoring and detecting loosening and/or detaching of a component of a machine. The systems and methods employ a wireless sensor network platform including sensor nodes and sink nodes operating at an radio frequency (RF) that is about one order of magnitude lower than a standard WSN RF of 2.4 GHz. At least one sensor node comprising at least one sensor element is deployed in or on the component of the machine, or deployed in or on the machine at a point where the component is attached. The sensor node sends a signal to the sink node upon sensing loosening and/or detaching of the component, and the sink node generates an alarm. Embodiments provide real-time detection and localization of a detached machine component to facilitate fast retrieval of the component. Therefore, damage caused by the detached component reaching critical downstream components can be avoided.

### FIELD

This invention relates to systems and methods for wirelessly detecting loosening and detaching of components of machinery, and for locating detached components.

### BACKGROUND

In certain industries, equipment failure due to loss or breakage of a critical component can cause significant setbacks and downtime, due to comprised activity of the equipment exhibiting the failure, as well as possible damage to downstream equipment. For example, in a rock crushing scenario, a component that becomes separated from a shovel can enter a crusher and cause significant damage and downtime.

Such is the case in oil sands mines, where conveyor belt and crusher damage routinely results from trapped steel components that become separated from upstream equipment, such as shovels. Commercial metal detection systems have been tested on the primary crusher hopper with mixed success. Systems based on digital imaging have also been tested and found to have low reliability due to the harsh conditions of the mine, making lighting, vibration, and dust significant factors in these vision systems. It is known to use RFID tags to locate loose metal components; however, to date, no effort has been made to adapt this technology with reliable configurations to applications such as oil sands shovels.

### SUMMARY

Described herein is a monitoring system for detecting loosening and/or detaching of a component of a machine; comprising: a wireless sensor network (WSN) platform that operates at a radio frequency (RF) that is about one order of magnitude lower than a standard WSN RF of 2.4 GHz; at least one sensor node comprising at least one sensor element, the sensor node being deployed in or on the component of the machine, or deployed in or on the machine at a point where the component is attached; and at least one sink node deployed on the machine; wherein the sensor node sends a signal to the sink node upon sensing loosening and/or detaching of the component, and the sink node generates an alarm.

In one embodiment, the WSN operates at an RF of about 433 MHz.

In one embodiment, the system comprises at least three sink nodes; wherein the monitoring system detects location of the detached component of the machine using multilateration.

In a further embodiment, the at least three sink nodes comprise one or more mobile sink node deployed on one or more mobile machine, and one or more fixed sink node deployed on one or more fixed structure.

In one embodiment, the at least one sensor node includes at least one sensor element selected from a capacitive proximity sensor, an inductive proximity sensor, and a mechanical contact sensor.

In one embodiment, the at least one sensor node is deployed in a shovel tooth of an excavating shovel or in a shovel tooth adapter of an excavating shovel. In another embodiment, a sensor node is deployed in a shovel tooth of an excavating shovel, wherein the sensor node includes a capacitive proximity sensor element. In another embodiment, a sensor node is deployed in a shovel tooth adapter of an excavating shovel, wherein the sensor node includes an inductive proximity sensor element and a mechanical contact sensor element.

The machine may be a shovel in an oil-sands operation, wherein the component of the machine is a shovel tooth.

Also described herein are methods of monitoring and/or detecting loosening and/or detachment of a component of a machine in accordance with the above embodiments. The methods may comprise: operating a WSN platform at an RF that is about one order of magnitude lower than a standard WSN RF of 2.4 GHz; deploying a sensor node in or on the component of the machine, or deploying the sensor node in or on the machine at a point where the component is attached, the at least one sensor node comprising at least one sensor element; deploying at least one sink node on the machine; and configuring the sensor node to send a signal to the sink node upon sensing loosening and/or detaching of the component, such that the sink node generates an alarm.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIG. 1 is a block diagram showing main components of a WSN platform according to one embodiment.

FIG. 2 is a diagram showing a localization technique based on multilateration with three sink nodes; according to one embodiment.

FIG. 3A is a diagram of a shovel tooth adapter with a shovel tooth installed.

FIGS. 3B and 3C are diagrams of a shovel tooth adapter.

FIG. 4 is a diagram of an inductive proximity sensor, according to one embodiment.

FIG. 5 is a diagram of a capacitive proximity sensor, according to one embodiment.

FIG. 6 is a diagram of a push-back sensor, according to one embodiment.

FIG. 7 is a circuit diagram of a sensor node showing main components, according to one embodiment.

FIG. 8 is a chart showing various equipment detachment scenarios and corresponding outputs, according to one embodiment.

FIG. 9 is a flow chart showing system operation, according to one embodiment.

FIG. 10 is a flow chart showing system operation during a detachment procedure, according to one embodiment.

### DETAILED DESCRIPTION OF EMBODIMENTS

Described herein are methods and systems comprising hardware and software for monitoring vulnerable components of machinery, i.e., components that are known or expected to break or detach through normal usage. For example, embodiments may be used to monitor a ground-engaging tool (GET) of an excavating machine, such as a shovel tooth on shoveling equipment. A wireless sensor network (WSN) platform is used to monitor the components, and, if a component becomes detached, the WSN allows its location to be determined. The WSN employs sensor elements mounted on the machine, to monitor a vulnerable component, which may include hardware mounted on the component expected to become detached, and/or mounted to the machine at the location where the component is normally attached. Multiple sensors may be used to monitor a single component, and multiple components may be monitored. Monitoring may include one or more of detecting presence of a component in its normal (attached) state, detecting a state where a component is loose or detachment of the component is imminent, detecting complete detachment of a component, and detecting location of a detached component.

In various embodiments, a sensor element may employ any of a variety of sensing technologies. A combination of different sensing technologies may be used. Single or combinations of sensor elements may be selected based on the nature of the environment and machinery being monitored and detected. For example, in certain applications, a sensor element may employ magnetic field and ultrasound sensing technologies. However, in particularly harsh environments, preliminary testing has revealed that ultrasonic sensing does not provide acceptable performance. Thus, in such harsh environments, embodiments employ other sensing technologies, such as induction and proximity sensor elements, as described herein.

It is desirable that sensor hardware is physically compatible with existing machinery, to avoid the need for modification of the machinery. For example, embodiments may be provided in a form that fits into suitable spaces, cavities, chambers, etc., in the machinery. However, this introduces significant design constraints, resulting in the communication and power technologies described herein that overcome the constraints, allowing such chambers to be used as access points. For example, to overcome the challenge of placing a sensor element and associated communications hardware in a metallic cavity, a lower WSN radio frequency (RF) range was used. In one embodiment, the lower RF range is about one order of magnitude less than that typically used for WSNs.

Embodiments provide real-time detection of a detached machine component, wireless communication while the detached component may be buried under rock, oil sand, debris, etc., accommodate wireless communication with minimal or no modification to the machinery, and optimize power consumption. Moreover, in a harsh operational environment with constant impacts and vibration, a resilient and rugged sensor platform is required. Therefore, embodiments detect detached equipment components through redundant sensing mechanisms and optimized accessibility, and provide a reliable localization strategy to find a detached component, in order to facilitate fast retrieval of the component before it reaches critical downstream components.

As used herein, the term “sensor element” (SE) refers to a hardware sensor based on a specific sensing technology, such as a capacitive proximity sensor, an inductive proximity sensor, or a contact sensor.

As used herein, the term “sensor module” (SM) refers to a component that includes one or more sensor element, and associated analogue or digital interface circuitry, and any associate software or firmware. Sensor elements of different sensing technologies may be included in a sensor module.

As used herein, the term “sensor node” (SN) refers to a component to which sensor modules are connected, and includes interface and communications circuitry, and provides communication with the WSN.

### WSN Platform

Various WSN platforms are known and may be adapted to implement embodiments described herein. For example, Sprouts™ (see, e.g., www.sensornodes.com/sprouts) provides a platform that may be used, with suitable adaptations, for the embodiments. In general, a WSN platform may be adapted and/or implemented such that it uses sensor nodes to collect data from sensors and report them to a sink node (i.e., a coordinator), where the coordinator transfers the collected data to a backend server for further data processing and visualization.

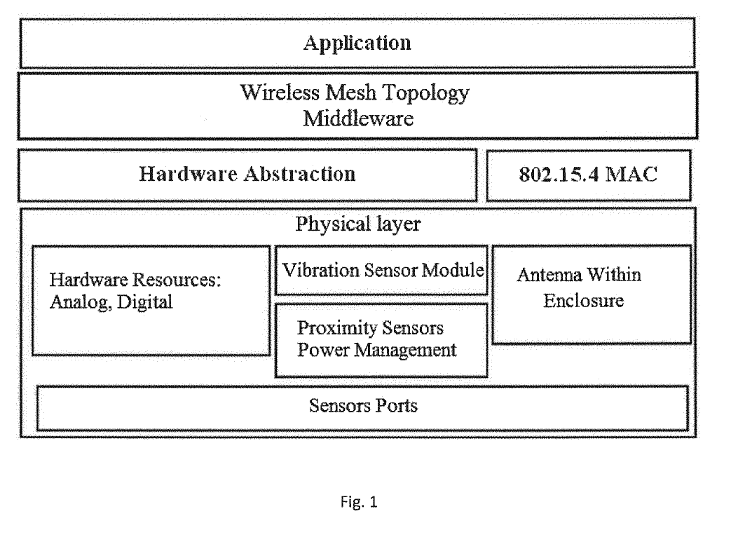

However, the heavy machinery application of the embodiments described herein places significant design constraints on the WSN. For example, the harsh environment together with the desire to avoid or minimize any modification to existing equipment requires disposing a sensor element and associated WSN communications hardware in metallic cavities of the equipment. A standard WSN implemented in such a setting suffers from substantially degraded performance. It was discovered that this constraint could be overcome by lowering the WSN frequency range used. It is believed that the lower frequency allows the wireless signal to penetrate small openings between a metal component and its mounting location in a cavity of the machine. In one embodiment, the RF range was reduced by about one order of magnitude less than the 2.4 GHz typically used for WSNs. An implementation with a WSN platform based on a wireless M-Bus is shown in FIG. 1. This embodiment provided good performance operating at 433 MHz. The WSN employs middleware architecture which provides for remotely reconfigurable and upgradable software modules.

Further adaptations of the WSN platform provide improved power management for ultra-low power consumption. Each SN includes a vibration sensing capability that optimizes battery use and prolongs the lifetime of the overall sensing network. Each SN may be customized based on the type of SM and SE required, providing an optimal solution for monitoring industrial equipment in harsh environments. The hardware features a small footprint and is very rugged, which enables the platform to be adapted to fit in existing equipment to be monitored, and to withstand harsh conditions (e.g., shock, vibration, high temperature, impact).

### Sensor Deployment

To detect detached equipment components multiple SMs are integrated into SNs. This serves both redundancy and resilience under the harsh environment, and aids in the efficiency of the system and its accuracy in detecting breakage and reporting it in real-time. As described in detail in the below Example, the detachment detection system may include inductive and capacitive proximity sensor elements, as well as mechanical push-back sensor elements that detect loosening and separation between two pieces of equipment. Of course, a detachment detection system may be configured with the type and number of sensor elements suitable for a given application. The sensor elements are connected to a SM that is programmed to collect information and report the information to the SN.

The SNs are housed in ruggedized enclosures to protect the node's components against harsh environmental factors. The enclosure is an integral feature of an SN when deployed in harsh environments. For example, a copper enclosure may be used to protect an SN against oxidation. Further, various measures may be taken to protect an SN. For example, the platform may be completely encapsulated within multiple layers of silicone and epoxy. Silicone (e.g., Shore hardness of less than 30 A) may be used to absorb shock, cushioning printed circuit board (PCB) components. A silicone encapsulated SN may then be encapsulated in epoxy to provide the SN with a structure that is extremely resilient to shock and vibration, water proof, and temperature tolerant. For example, an epoxy with a Shore hardness of 60D or more may be used.

Given the harsh nature of industrial environments, fault tolerance is also considered throughout the WSN software and network architecture. For example, error recovery functions from software failures on a sensor node may be implemented by reinitializing specific hardware components, software resets, watchdog timers, and voltage level monitoring. Some embodiments may include using backup memory containing original firmware.

In operation, a SE undergoes a change of state upon the loosening or detaching of a component of the equipment being monitored. For example, the change of state may be output as a gradual change in a signal, related to a gradual degradation in the connection of the component to the equipment, or the change of state may be a simple binary output. An indication of the change of state, such as an output signal, may be sent to the SM automatically, or the SM may interrogate the SE at selected intervals (e.g., as a power-saving strategy) to obtain the indicating signal. Accordingly, the SM may include suitable circuitry to interface with the SE, including, for example, a microcontroller. The SM then triggers the SN to transmit an alarm signal (e.g., alarm packets) to a coordinator on the equipment. The alarm signal is translated into an audible and/or visual alarm displayed to the equipment operator. Simultaneously, the alarm packets are routed by the coordinator to a main server, to be filtered and visualized on further monitoring devices.

### Localization

As mentioned, a machine component that becomes detached must be located as soon as possible, to prevent damage to other equipment. A sensor node in such a component starts sending beacons at predefined intervals to sink nodes. The sink nodes may be deployed on the machine, other vehicles (i.e., mobile sink nodes), and/or on selected structures throughout the field (i.e., fixed sink nodes).

In order to communicate with the embedded sensor nodes in the detached equipment component, multiple locations provide a greater chance of communication with sink nodes. Sink nodes may be equipped with high gain antennas, and the resources to compute and store large amounts of information.

A mobile sink node on a particular mobile machine may initiate communication with a monitored component that becomes detached from that mobile machine, due to their proximity.

Fixed and mobile sink nodes may include any or all of the following features:
1. High directivity gain antenna and a high receiver sensitivity.
2. High speed processor.
3. Peripherals:
   a. WiFi communication with other monitoring devices;
   b. Alarm devices (e.g., audio, visual).
4. GPS module (to aid in estimating the fallen equipment location).
5. Unlimited local power from the mobile machine.

Fixed sink nodes may be deployed on selected structures and/or along routes travelled by mobile machines. For example, fixed sink nodes may be deployed along paths travelled by trucks to reach the final dumping zone into crusher. The importance of these “location gates” stems from the crucial detection phase prior to reaching the crushers where significant damage can occur. Therefore, fixed sink nodes are mounted with high sensitivity antennas to detect a signal beaconed from a sensor node inside a detached component that is in the load of a shovel truck. Accordingly, fixed sink nodes are deployed such that paths of all trucks at risk of having a fallen component in their load would be covered.

For localization it is important to consider the correlation between the received signal strength intensity (RSSI) of the received signal from a sensor node in a detached component, its directivity, and the number of readers required to receive the signal. Thus, to boost reception, mobile sink nodes may be equipped with a GPS receiver to act as anchors in the multilateration process. To localize a detached component, a RSSI based localizing method with multilateration is applied by the sink nodes to determine the location by adjustable power level.

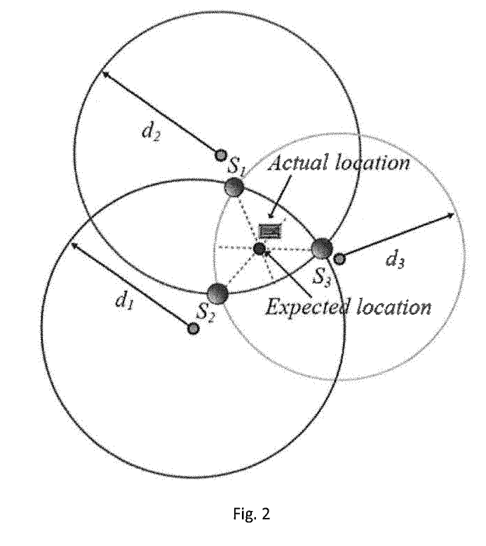

FIG. 2 shows an example of such localization. The component can be localized in two dimensions when three mobile/fixed sink nodes (or more) detect its RSSI, and each sink node maps it to a distance value (d₁, d₂, d₃) that is considered to be the radius of a circle with the sink node at the center. As the sensor node antennas provide three RSSI readings, the reliability of the estimation scheme is increased and each radius d is mapped to the average RSSI from each antenna. The intersection between the resulting circles is used to estimate the location of the shovel-tooth.

An exemplary embodiment is described in detail below. However, the invention is not limited thereto, as it will readily be appreciated that embodiments may be adapted for implementation in other heavy equipment applications.

### Example

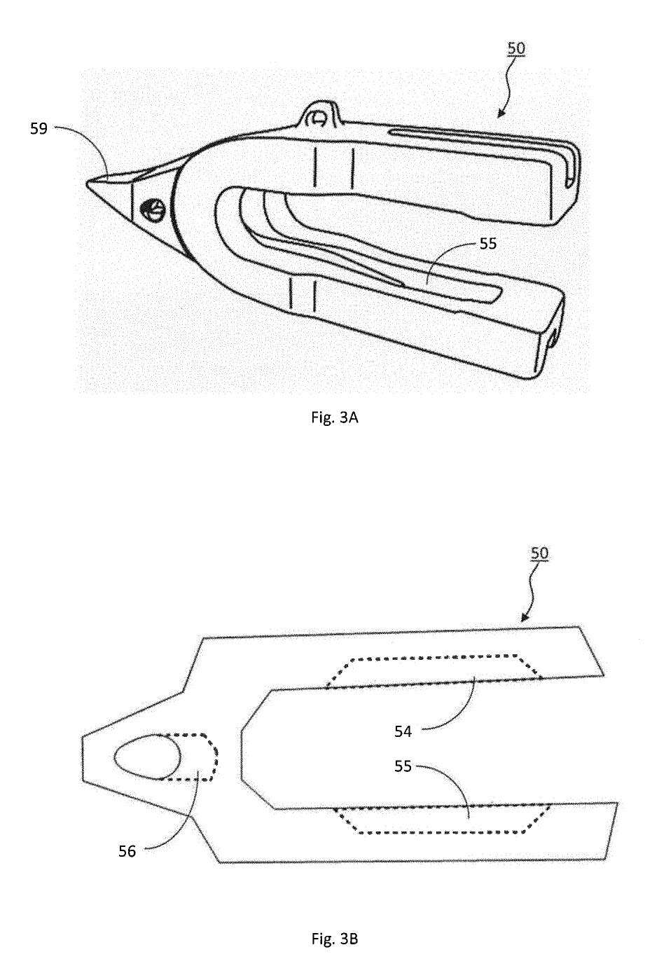

In this example, a WSN was implemented in an oil sands operation. Oil production from oil-sands (e.g., oil sands mining operations in Fort McMurray, Alberta, Canada) begins with shoveling the oil-impregnated sand found within layers of rock in preparation to crush it. Excavation shovels are used 24 hours per day, year round, to collect the oil sand. The shovel bucket is equipped with shovel teeth which are mounted to the bucket with shovel teeth adapters. FIG. 3A is a diagram of a shovel tooth adapter 50 with a shovel tooth 59 attached. Due to the continuous impact of the shovel teeth with rock, teeth and tooth adaptors routinely break off.

When a shovel tooth or tooth adaptor becomes detached, several problems may occur. For example, the shovel lip may become exposed and may become damaged from impact with rock, preventing proper attachment of a new shovel adaptor. Also, the fallen shovel tooth or tooth adaptor could puncture a truck tire, which is expensive and produced by only few companies in the world. Further, the detached shovel tooth may get shoveled with the load and make its way into the crusher or conveyor, resulting in serious damage, and downtime in the oil production process.

In the field, poor weather conditions and environmental hazards limit the opportunity for inspection and involvement by technicians. Accordingly, automated monitoring of shovel teeth and adaptors and immediate notification and localization of a detached component is of utmost importance. However, there are significant challenges to implementing a wireless sensor network. For example, sensors cannot be attached to the outside of the shovel-tooth because of frequent impacts and constant erosion. Further, modification of shovel teeth to allow internal attachment of sensors is undesirable, given the heavy steel construction of the teeth and associated difficulties of modifying.

For these reasons, the WSN was designed to use hardware sensors adapted to be attached to existing shovel teeth and tooth adapters with minimal or no modification. The sensors were adapted to fit into existing cavities in the shovel teeth and tooth adapters, such that the sensors were substantially encompassed by steel. However, this presented a further challenge, in that the conventional WSN frequency of 2.45 GHz and its power requirements were unsuitable for sensors in such a difficult operating environment.

To overcome the challenge of placing a sensor in a metallic cavity, a lower WSN RF range was used, to allow the wireless signal to penetrate small openings between the shovel tooth and its mounting location on the tooth adapter or equipment body. For the lower frequency range, the transceiver was designed to transmit at 433 MHz. The 433 MHz signal allows 2 to 3 km in line-of-sight transmission compared to only 100 to 150 m in the case of 2.54 GHz under the same power constraints.

FIGS. 3A, 3B, and 3C are diagrams of a tooth adapter 50 showing the cavities 54, 55, 56 where sensor nodes may be deployed.

### Sensor Elements

### I. Inductive Proximity Sensor (IPS) Element

An inductive proximity sensor element may be a commercially available sensor, obtained from a parts supplier, or one that is custom made. In general, an inductive proximity sensor operates under the electrical principle of inductance, wherein a fluctuating current in a conductor produces a magnetic field that induces an electromotive force (EMF) in a target object. The conductor may be wound into a coil to increase the inductance in the target object.

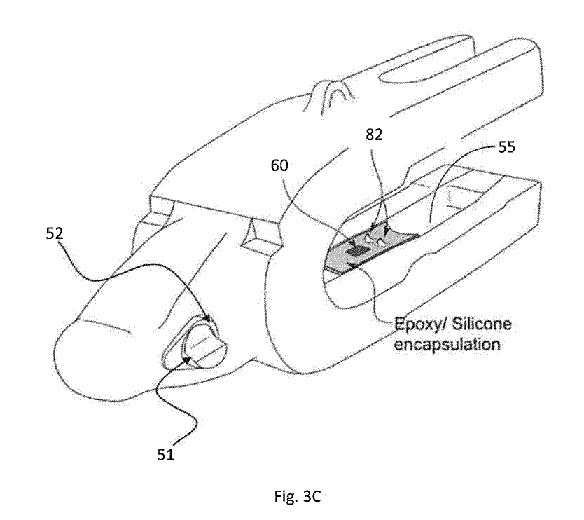

An embodiment of an inductive proximity sensor is shown schematically in FIG. 4. The sensor 60 includes power connections 64, a coil 68, an oscillator 66, a detection circuit 67, and an output 65. The oscillator generates a fluctuating magnetic field 69 around the winding of the coil (i.e., in the shape of a toroid), oriented in the sensor's sensing face.

In use, the IPS causes eddy circuits to build up in the target metallic object, which eventually reduce the IPS oscillation field of the IPS. The detection circuit 67 monitors the oscillator's strength and produces an output signal when the oscillator strength becomes reduced to a selected level. A sensor node including an IPS 60 may be deployed in a cavity 55 of a shovel tooth adapter as shown in FIG. 3C. Upon detachment of the target object (e.g., a shovel tooth adaptor, a shovel tooth), the IPS returns to its normal operation, causing the SM to output a signal to the SN to issue an alarm message to a base station coordinator, which may be deployed in the shovel operator cabin.

### II. Capacitive Proximity Sensor (CPS) Element

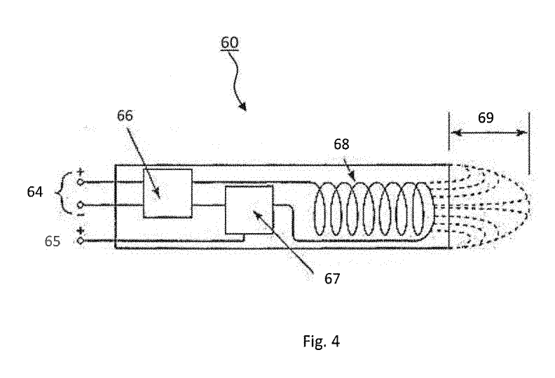

A capacitive proximity sensor element may be a commercially available sensor, obtained from a parts supplier, or one that is custom made. In general, a CPS functions like a capacitor. An embodiment of a capacitive proximity sensor is shown schematically in FIG. 5. The sensor 70 includes an electrode 73 as one (internal) plate of the capacitor. The electrode is connected to an oscillator 74, which is controlled by a signal conditioning circuit 75 connected to an analog-to-digital converter ADC 76. A calibration circuit 71 may optionally be provided. The second (external) plate of the capacitor is provided by an object being sensed (the target object), such that an electric field 72 is produced between the plates. The signal conditioning circuit 75 senses the capacitance between the external plate (target object) and the internal plate, which is dependent upon proximity of the sensor internal plate and the target object. Thus, the CPS produces a signal corresponding to a normal state or an alarm state based on proximity of the target object.

In this example a CPS element was deployed in the cavity 56 of the tooth adapter 50, and used to detect detachment of a shovel tooth from the tooth adapter.

### III. Push-Back Sensor (PBS) Element

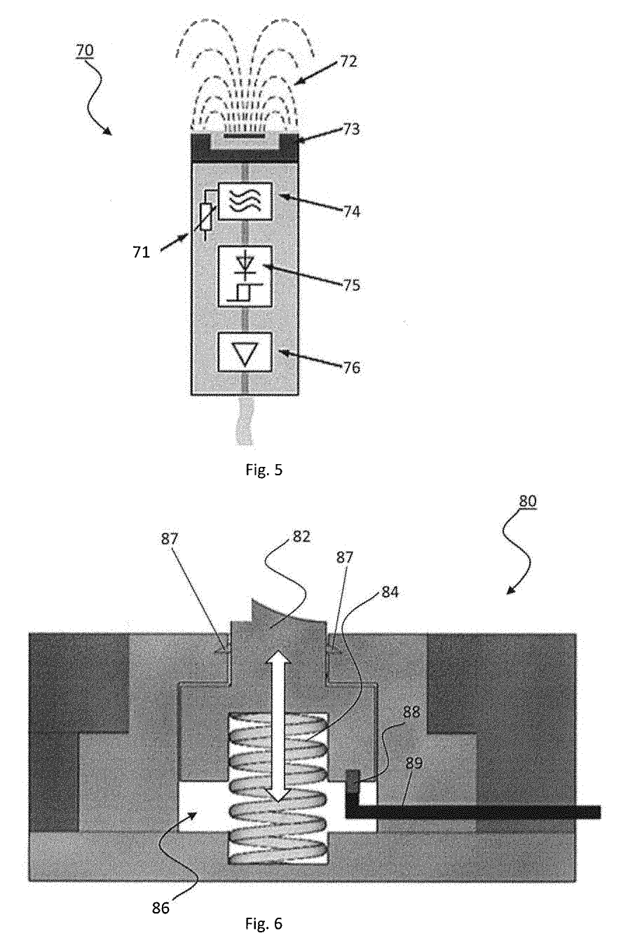

To increase detection reliability, a second sensor is used. This sensor element is a mechanical sensor that senses the mechanical interface between first and second surfaces, which may be surfaces corresponding to first and second joined components. The PBS is deployed on the first component, and employs push-back claws that contact a surface of the second component. The PBS may provide a signal corresponding to a normal state (e.g., the two components being attached) and/or an alarm state wherein the two components are loose and/or detached. For example, a PBS may be used to monitor contact between a shovel tooth and tooth adapter, and/or between a tooth adapter and shovel bucket. An embodiment is shown in cross-section in the diagram of FIG. 6.

Referring to the embodiment of FIG. 6, each PBS 80 includes at least one claw 82 that contacts a surface of a second component. Each claw can freely travel in an axial direction shown by the double-headed arrow, and is biased against a surface of the second component by a spring 84, housed in a spring chamber 86. Suitable seals 87 may be employed, such as flexible rubber gaskets, brushes, and the like, to prevent debris from reaching the spring chamber and fouling the mechanism. The claw has a selected axial displacement to accommodate deformation and wear between the adjacent surfaces. For example, for deployment between a shovel tooth and tooth adapter, the displacement may be about 0.25 inches. Axial displacement of the claw is sensed by a sensor component 88. In one embodiment the sensor component 88 includes electrical contacts connected to wiring 88 that maintain a short or closed circuit when the at least one claw 82 is in contact with the surface of the second component and forced downward in the axial direction, indicating a normal state. Upon loosening or detachment of the second component, the at least one claw 82 is biased upward in the axial direction, resulting in an open circuit condition indicating an alarm state.

In use, a PBS may be mounted in one or both of the arms of a shovel tooth adapter. As long as the push-back claws are touching the lip of the bucket on which the tooth adapter is mounted, the SM microcontroller reads a corresponding “short circuit” value at a predefined input port. Upon detachment of the tooth adapter arm, the SM reads an “open circuit” and triggers the SN to generate a corresponding alarm procedure. In addition to its main function in detecting detachment of a tooth adapter arm, a PBS may also be configured to trigger the operation of the SN once the tooth adapter is installed on the bucket.

### Sensor Nodes

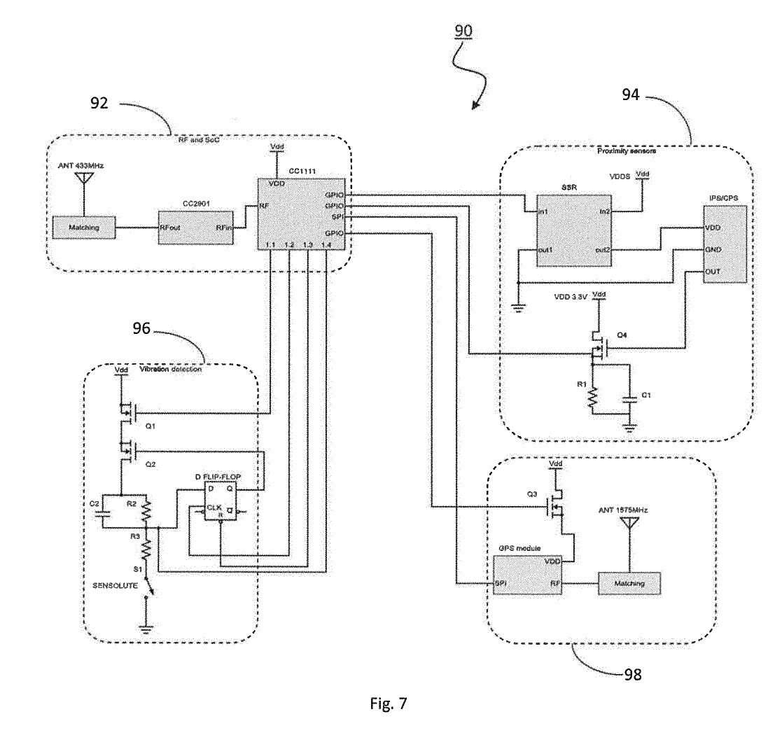

FIG. 7 is a circuit diagram showing a sensor node 90, according to one embodiment. The sensor node includes one or more sensor element, one or more sensor module, communications, processor, power management, and control components, and one or more antenna. For example, a controller 92 may include a system on chip (SoC) integrated circuit (IC) that combines a processor (i.e., a microcontroller (MCU)) and radio frequency (RF) transceiver. The CC1111 from Texas Instruments Inc. (Dallas, Tex., USA) is an example of a suitable SoC. The CC111 RF transceiver operates at both 915 MHz and 433 MHz channels. The MCU controls data flow from/to the sensors and forwards the collected or processed data to the transceiver. The transceiver signal from the SoC may be further amplified by a RF amplifier, such as the CC2901 from Texas Instruments Inc. Both the SoC and the RF amplifier provide a superior detection range even though the sensor is embedded inside the tooth adapter tip or arms (with, e.g., only about a 3 mm opening).

The controller 92 may be connected to different types of sensor elements, shown at 94, examples of which are described above. For example, the controller may be connected to a CPS mounted in the tooth adapter tip, and to an IPS and PBS mounted in a tooth adapter arm. Both the CPS and the IPS are high current-consuming sensors, so they may be powered by a higher voltage than the SoC to optimize the power consumption rate. A solid state relay (SSR) chip may be used to switch on the power whenever a reading is required (e.g., turn ON SSR, read data from sensor element, turn OFF SSR). This extends the lifetime of the batteries, and maintains a timely reading regime from the sensor elements.

Since the shovel may not be in use 100% of the time, sensor nodes may be switched off when the shovel is not in operation to save power and unnecessary reporting. In one embodiment this may be achieved by a vibration sensor 96 that is connected to an interrupt line of the SoC. Whenever the shovel is not vibrating with a predefined G-force (i.e., not in use), the SoC will go into a deep sleep state that requires an external interrupt signal to start again. Once the shovel resumes its operation, the vibration sensor circuit triggers an interrupt signal to allow the SoC to resume its sensing and reporting functions.

In some embodiments a GPS module 98 may be included in a sensor node to enhance localization accuracy. Use of a GPS module requires consideration of the overall power consumption of the node.

For high durability and reliability, the sensor node may be designed with military or automotive rated components. In addition, all the components may be encapsulated in a protective material such as silicone to reduce shock and vibration.

### Sensor Node Deployment

Sensor nodes including proximity sensor elements and push-back sensor elements may be mounted in the upper and lower arms and the tips of the tooth adapter, as shown in FIGS. 3A and 3B, to take advantage of the cavities 54, 55, and 56 in the casting. The cavities have sufficient volume to accommodate the sensors and high capacity batteries. In the view provided by FIG. 3C, a sensor node including an IPS 60 and a PBS 80 can be seen mounted in a cavity 55 of the lower arm, with two push-back claws 82 protruding. The sensor node is typically encapsulated in epoxy/silicone for protection. FIG. 3B shows the cavities 54, 55 in the upper and lower arms and a cavity 56 in the tip of a tooth adapter where sensors may be mounted. A sensor node including a CPS may be deployed in the cavity 56 at the tip of the adapter. This installation exploited a spacing between the shovel tooth mounting pin 51 and the pin opening 52 to transmit the RF signal, and good transmission range was obtained (e.g., up to 15 m) while the sensor was transmitting at 433 MHz.

### Scenarios Monitored and Detected

According to the embodiment described herein, the system is designed to monitor and detect a loose or detached component such as a shovel tooth or tooth adapter (with or without a tooth attached), or a loose or detached part of a tooth adapter (with or without a tooth attached).

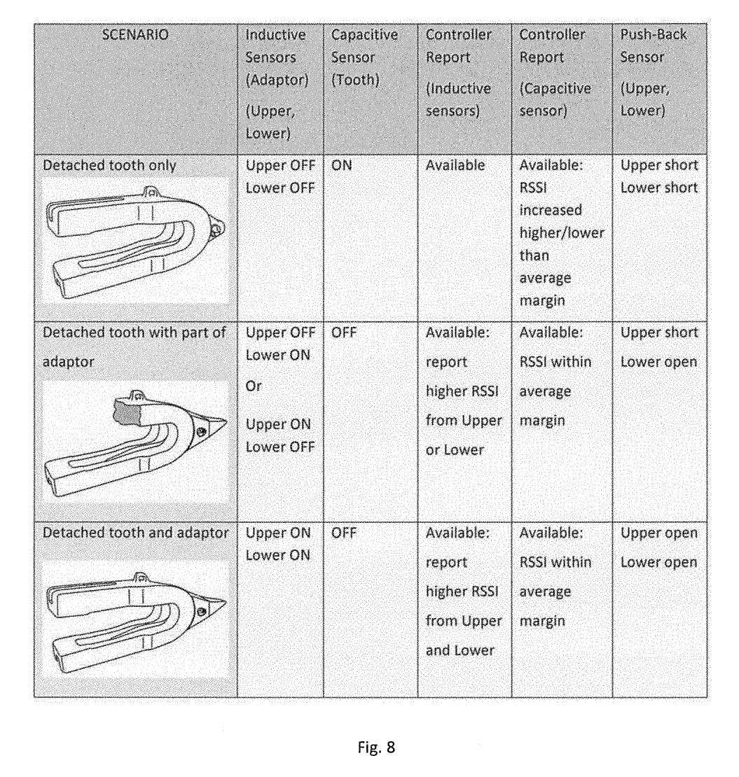

Importantly, the provision of three sensors on each tooth adapter allows for detecting a partial break. FIG. 8 is a chart exemplifying such various scenarios with associated sensor status, controller reports, and received signal strength intensity (RSSI). The system may include a further feature that detects any inconsistency in the reported data, and triggers an alarm so that the adapter and tooth condition can be directly investigated.

### System Operation

All sensor nodes communicate over the WSN with a sink node placed at a central location. Generally, the sink node is placed in the shovel operator cabin. The embodiment described in this example exhibited good detection range results (about 15 m), providing acceptable communication range without the use of an amplifier. An amplifier would boost the output power from about 7 dBm to about 27 dBm, giving a theoretical two orders of magnitude increase in the transmitted power. Also, the receiver used at the sink node had a low gain antenna with no amplifier. Since the cabin of the shovel can accommodate a larger high gain antenna, the expected range in the field deployment would then be much larger than 15 m.

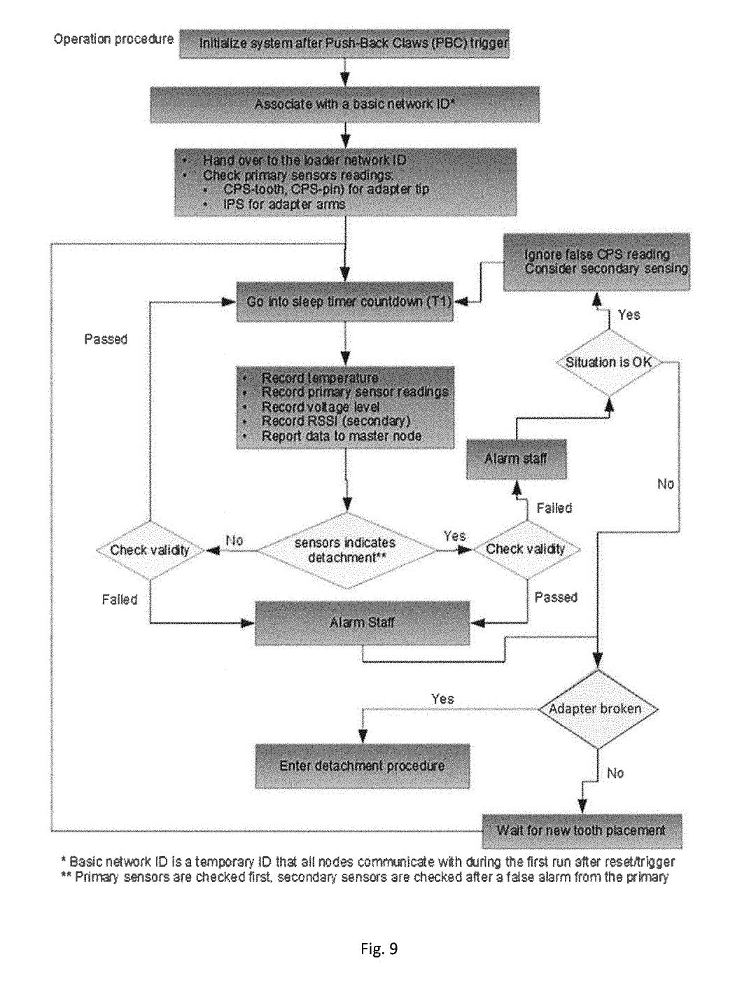

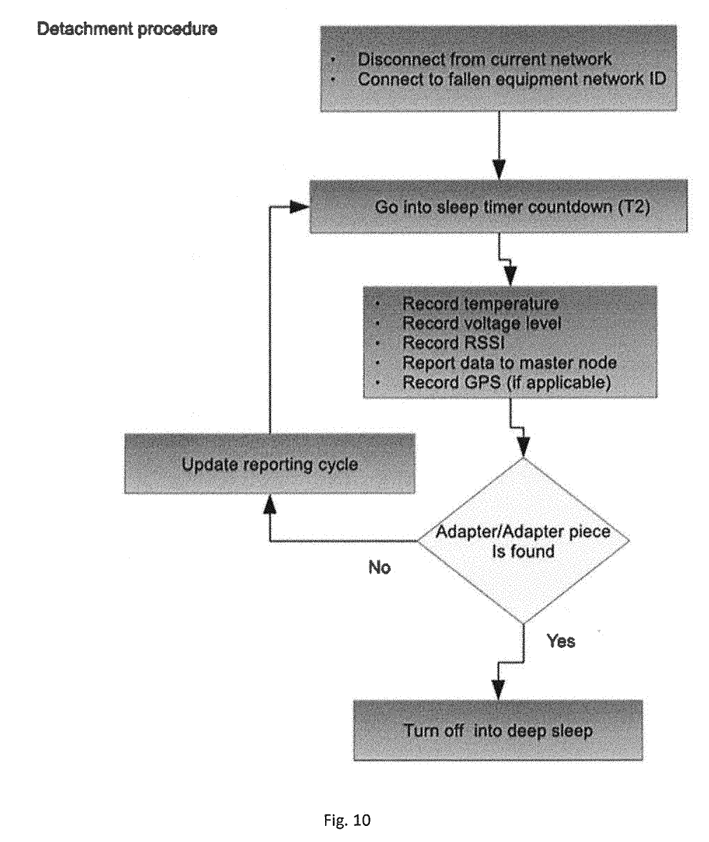

FIG. 9 is a flowchart illustrating basic system operation. In FIG. 9, primary sensors are inductive proximity sensors and capacitive proximity sensors, and secondary sensors are push-back sensors. FIG. 10 is a flowchart illustrating system operation upon detachment of a part, and for controlling the sleep cycle. After system initialization, which in this embodiment is triggered by the PBC sensor, primary sensor readings are checked and if there is no alarm, the node enters a sleep mode. The duration of the sleep mode may be controlled using a timer. When the sleep duration has expired, the node wakes up and records relevant data (e.g., temperature, voltage levels of sensors, RSSI from sink nodes, GPS data (if the node is equipped with GPS), etc.). If detachment of a tooth or adapter is detected and validated, the sensor node in the fallen equipment is identified in the network based on a pre-stored unique identification (ID) value that is pre-stored in each sensor node. Associated data (e.g., temperature, sensor voltage levels, RSSI from sink nodes, GPS data (if the node is equipped with GPS) is recorded and reported to the fallen equipment sink nodes, and appropriate alarms are generated. The process of sleep/wake/record/report may be repeated until the detached component is located by the field staff.

### Localization

Upon detachment each sensor node starts sending beacons at predefined intervals to fixed and mobile sink nodes to assist in retrieving the shovel tooth from the field to prevent it from reaching the conveyor and crusher. This is achieved by deploying mobile sink nodes on mobile equipment such as bulldozers, heavy haulers, and light duty trucks, and by deploying fixed sink nodes on selected structures and/or along routes travelled by mobile machines.

To boost reception, sink nodes were placed on mobile equipment with GPS receivers to act as anchors in the multilateration process for shovel tooth localization (see FIG. 2). To localize a detached shovel tooth, an RSSI based localizing method with multilateration was applied by the sink nodes to determine the location by adjustable power level.

All cited publications are incorporated herein by reference in their entirety.

### EQUIVALENTS

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

1. A monitoring system for detecting loosening and/or detaching of a component of a machine; comprising:
a wireless sensor network (WSN) platform that operates at a radio frequency (RF) that is about one order of magnitude lower than a standard WSN RF of 2.4 GHz;
wherein the WSN comprises:
at least one sensor node comprising at least one sensor element, the sensor node being deployed in or on the component of the machine, or deployed in or on the machine at a point where the component is attached; and
at least one sink node deployed on the machine;
wherein the sensor node sends a signal to the sink node upon sensing loosening and/or detaching of the component, and the sink node generates an alarm.

2. The monitoring system of claim 1, wherein the WSN operates at a RF of about 433 MHz.

3. The monitoring system of claim 1, comprising at least three sink nodes;
wherein the monitoring system detects location of the detached component of the machine using multilateration.

4. The monitoring system of claim 3, wherein the at least three sink nodes comprise one or more mobile sink node deployed on one or more mobile machine, and one or more fixed sink node deployed on one or more fixed structure.

5. The monitoring system of claim 1, wherein the at least one sensor node includes at least one sensor element selected from a capacitive proximity sensor, an inductive proximity sensor, and a mechanical contact sensor.

6. The monitoring system of claim 1, wherein the at least one sensor node is deployed in a shovel tooth of an excavating shovel or in a shovel tooth adapter of an excavating shovel.

7. The monitoring system of claim 1, wherein a sensor node is deployed in a shovel tooth of an excavating shovel, wherein the sensor node includes a capacitive proximity sensor element.

8. The monitoring system of claim 1, wherein a sensor node is deployed in a shovel tooth adapter of an excavating shovel, wherein the sensor node includes an inductive proximity sensor element and a mechanical contact sensor element.

9. The monitoring system of claim 1, wherein the machine is a shovel in an oil-sands operation, wherein the component of the machine is a shovel tooth.

10. A method of monitoring and/or detecting loosening and/or detachment of a component of a machine; comprising:
operating a WSN platform at a RF that is about one order of magnitude lower than a standard WSN RF of 2.4 GHz;
deploying a sensor node in or on the component of the machine, or deploying the sensor node in or on the machine at a point where the component is attached, the at least one sensor node comprising at least one sensor element;
deploying at least one sink node on the machine;
configuring the sensor node to send a signal to the sink node upon sensing loosening and/or detaching of the component, such that the sink node generates an alarm.

11. The method of claim 10, including operating the WSN at a RF of about 433 MHz.

12. The method of claim 10, comprising using at least three sink nodes;
wherein the monitoring and/or detecting includes detecting location of the detached component of the machine using multilateration.

13. The method of claim 12, comprising deploying one or more mobile sink node on one or more mobile machine, and deploying one or more fixed sink node on one or more fixed structure.

14. The method of claim 10, comprising at least one sensor node including at least one sensor element selected from a capacitive proximity sensor, an inductive proximity sensor, and a mechanical contact sensor.

15. The method of claim 10, comprising deploying the at least one sensor node in a shovel tooth of an excavating shovel or in a shovel tooth adapter of an excavating shovel.

16. The method of claim 10, comprising deploying a sensor node in a shovel tooth of an excavating shovel, wherein the sensor node includes a capacitive proximity sensor element.

17. The method of claim 10, comprising deploying a sensor node in a shovel tooth adapter of an excavating shovel, wherein the sensor node includes an inductive proximity sensor element and a mechanical contact sensor element.

18. The method of claim 10, comprising monitoring and/or detecting loosening and/or detachment of a component of a machine in an oil-sands operation, wherein the component of the machine is a shovel tooth.
